(19) United States
(12) Patent Application Publication
(10) Pub. No.: US 2025/0337767 A1
(43) Pub. Date: Oct. 30, 2025

(54) Internet-Exposed Device Discovery

(71) Applicant: CrowdStrike, Inc., Sunnyvale, CA (US)

(72) Inventors: Michael Glyer, Arlington, VA (US); Yotam Lichter, Eftat (IL); Yaron Tal, Ness Ziona (IL)

(73) Assignee: CrowdStrike, Inc., Sunnyvale, CA (US)

(21) Appl. No.: 18/650,238

(22) Filed: Apr. 30, 2024

(51) Int. Cl. H04L 9/40; H04L 61/2517; H04L 61/5076

(52) U.S. Cl. CPC H04L 63/1433; H04L 61/2517; H04L 61/5076; H04L 63/0236

(57) ABSTRACT

A cloud-based, external attack surface management (or EASM) service identifies computers, servers, smartphones, and other devices that are exposed to the public Internet. Any device that can connect to the public Internet may be vulnerable to cybersecurity attacks. The EASM service identifies a device exposed to the public Internet by comparing connection notifications to an address scan of the entire Internet. The connection notifications are sent by cybersecurity sensory agents installed at client devices. When a connection notification and the address scan of the entire Internet references a matching IP address and/or a matching port within a timeframe, the corresponding device is identified as being exposed to the public Internet.

### BACKGROUND

The subject matter described herein generally relates to computers and to networks and, more particularly, the subject matter relates to networked communications, to network security and monitoring, and to network discovery.

Cybersecurity threats are always increasing. Many cybersecurity attacks, for example, are delivered from the public Internet. If a computer, smartphone, or other device connects to the public Internet, then the device is vulnerable to cybersecurity attacks.

### SUMMARY

A cloud-based, external attack surface management (or EASM) service identifies computers, servers, smartphones, and other devices that are exposed to the public Internet. As we all know, any device that connects to the public Internet is vulnerable to cybersecurity attacks. The EASM service thus identifies devices that are exposed to the public Internet. The EASM service maintains a complete scan of all Internet Protocol (or IP) addresses associated with the public Internet. The EASM service also receives connection notifications sent by cybersecurity sensory agents installed at client devices in the field. Each connection notification indicates that a network connection was requested or accepted. When the EASM service receives a connection notification, the EASM service compares the IP addresses and ports described by the connection notification to the scan of all the IP addresses associated with the public Internet. When the connection notification and the scan have matching IP addresses and ports within a timeframe (such as 30 minutes), then the EASM service identifies the corresponding client device as being exposed to the public Internet. The corresponding client device, in other words, can receive network or packet traffic from the public Internet, so the client device is therefore vulnerable to cybersecurity attacks.

### BRIEF DESCRIPTION OF THE SEVERAL VIEWS OF THE DRAWINGS

The features, aspects, and advantages of Internet-exposure device discovery are understood when the following Detailed Description is read with reference to the accompanying drawings, wherein:

FIG. 1 illustrates some examples of Internet-exposed device discovery;

FIGS. 2-3 illustrate examples of address comparisons;

FIG. 4 illustrates examples of address matches;

FIG. 5 illustrates examples of port matches;

FIG. 6 illustrates examples of discovered, Internet-exposed devices;

FIG. 7 illustrates examples of web interfacing;

FIG. 8 illustrates more examples of discovered Internet-exposed devices;

FIGS. 9-10 illustrate examples of packet capture for discovering Internet-exposed devices;

FIGS. 11-12 illustrate examples of IP address scanning and correlation;

FIG. 13 illustrates some examples of local assessment;

FIGS. 14-16 illustrate examples of a method or operations that identify devices exposed to the public Internet; and

FIG. 17 illustrates a more detailed example of an operating environment.

### DETAILED DESCRIPTION

Some examples relate to discovering devices connected to the Internet. As we know, nearly every day we read of another network hack, computer virus, or other cybersecurity attack. Many of these cybersecurity attacks occur because our computers, smartphones, and other devices connect to the Internet. If we click on suspicious email link, for example, or open a suspicious attachment, or download a suspicious website, then our devices connect to the Internet and are vulnerable to cybersecurity attacks. Indeed, the risk of Internet exposure is greatly magnified when large computer networks (such as NETFLIX®, GOOGLE®, APPLE®, and AMAZON®) have hundreds or even thousands of servers. If just a single server were to unexpectedly connect to the Internet, then important cloud services may be taken down by bad actors and cybersecurity attacks.

An external surface attack management service, though, quickly and elegantly identifies Internet exposure. The external surface attack management (or EASM) service determines which devices are exposed to the Internet and, thus, which devices are vulnerable to cybersecurity attacks. The EASM service maintains a complete inventory of all the devices that are reachable from the Internet. The EASM service also receives connection notifications from the devices. Each connection notification indicates that a network connection was requested or accepted. When the EASM service receives one of the connection notifications, the EASM service may compare IP addresses and ports described by the connection notification to the scan of all the IP addresses associated with the public Internet. When the connection notification and the scan have matching IP addresses and ports within a timeframe (such as 30 minutes), then the EASM service identifies the corresponding device as being exposed to the public Internet. The corresponding device, in other words, can receive network or packet traffic from the public Internet, so the device is therefore vulnerable to cybersecurity attacks.

Internet-exposed device discovery will now be described more fully hereinafter with reference to the accompanying drawings. Internet-exposed device discovery, however, may be embodied in many different forms and should not be construed as limited to the examples set forth herein. These examples are provided so that this disclosure will be thorough and complete and fully convey Internet-exposed device discovery to those of ordinary skill in the art. Moreover, all the examples of Internet-exposed device discovery are intended to encompass both structural and functional equivalents thereof. Additionally, it is intended that such equivalents include both currently known equivalents as well as equivalents developed in the future (i.e., any elements developed that perform the same function, regardless of structure).

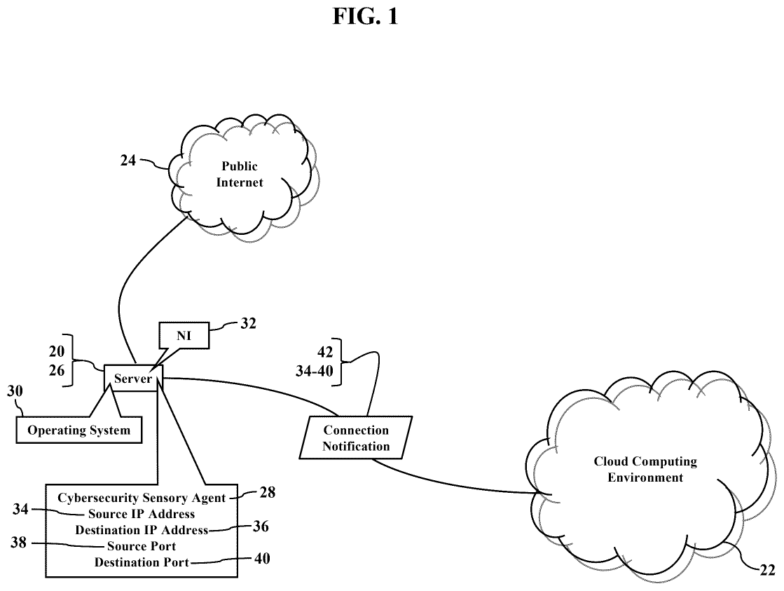

FIG. 1 illustrates some examples of Internet-exposed device discovery. A client device 20 notifies a cloud computing environment 22 of network communications conducted via a public Internet 24. FIG. 1 illustrates the client device 20 as a server 26, although the client device 20 may be a different processor-controlled device (as later paragraphs will explain). When the server 26 receives a communications request from the public Internet 24, the server 26 alerts the cloud computing environment 22 (e.g., public Internet, private network, and/or hybrid network). The server 26, for example, stores and executes a cybersecurity sensory agent 28. The cybersecurity sensory agent 28 is a software product that monitors the server 26 for network connections to and/or from computer networks. When the cybersecurity sensory agent 28, for example, detects that the server 26 received or accepted a communications request via a communication network (such as the public Internet 24), the cybersecurity sensory agent 28 cooperates with an operating system 30 and/or a network interface (or NI) 32 to obtain the communications details. The cybersecurity sensory agent 28, for example, interfaces with the operating system 30 to receive event notifications associated with transmission control protocol (TCP) communications, User Datagram Protocol (UDP), and other communications protocols utilized by the network interface 32. The cybersecurity sensory agent 28, for example, acquires a source Internet Protocol (or IP) address 34, a destination IP address 36, a source port 38, and/or a destination port 40 associated with network communications. The cybersecurity sensory agent 28 cooperates with the operating system 30 to generate and report a connection notification 42 to the cloud computing environment 22. The connection notification 42 alerts or notifies the cloud computing environment 22 that the server 26 has requested, accepted, and/or established network communication as referenced by the source IP address 34, the destination IP address 36, the source port 38, and/or the destination port 40.

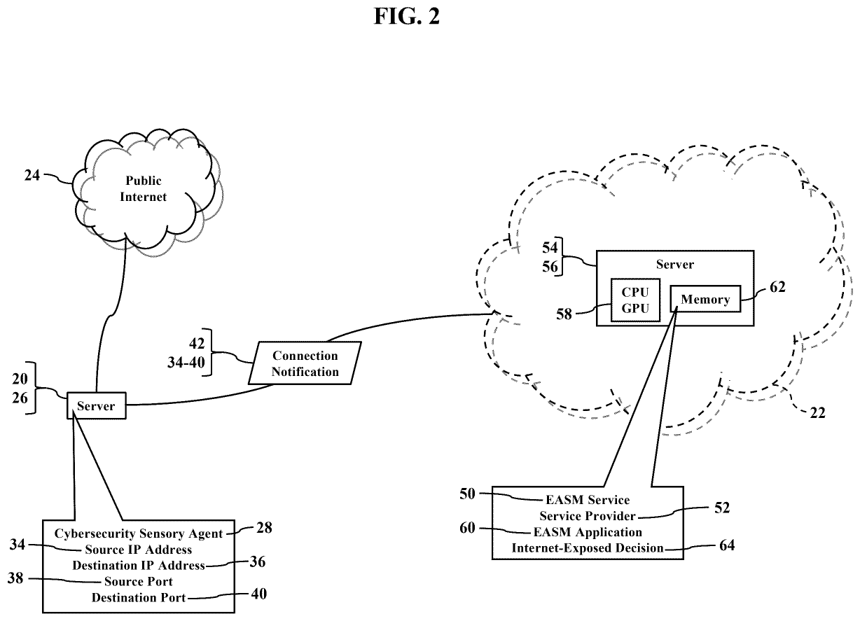

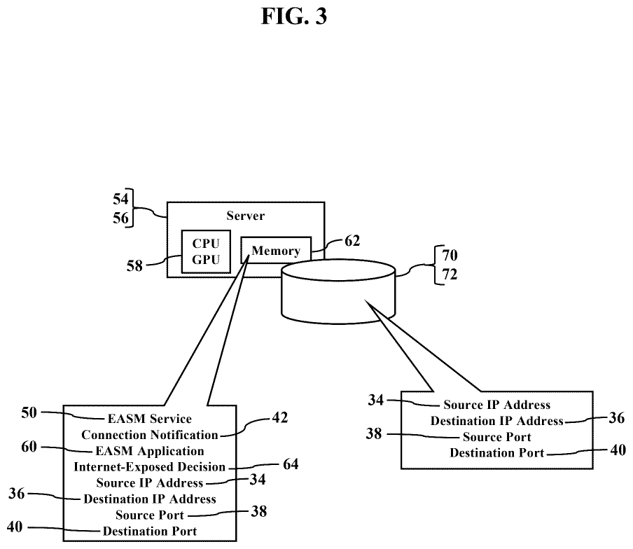

FIGS. 2-3 illustrate examples of address comparisons. When the cloud computing environment 22 receives the connection notification 42 sent by the client device 20 (again illustrated as the server 26), the cloud computing environment 22 provides an external attack surface management (or EASM) service 50 on behalf of a service provider 52. While the cloud computing environment 22 may have many networked components or members that cooperate to provide the EASM service 50, FIG. 2 only illustrates a simple example. When the cloud computing environment 22 receives the connection notification 42, the cloud computing environment 22 may route or forward the connection notification 42 to a computer system 54 that executes the EASM service 50. The computer system 54 operates in, and/or is affiliated with, the cloud computing environment 22. FIG. 2 illustrates the computer system 54 as a cloud-based server 56, although the computer system 54 may be a different processor-controlled device (as later paragraphs will explain). The server 56 has at least one hardware processor 58 (illustrated as “CPU/GPU”) that executes an external attack surface management (or EASM) application 60 stored in a memory device 62. The server 56 also has network interfaces (not illustrated for simplicity) to multiple communications networks (such as the cloud computing environment 22), thus allowing bi-directional communications with networked devices. When the server 56 receives the connection notification 42, the EASM application 60 accepts the connection notification 42 as an input and reads its accompanying parameters or fields (such as the source IP address 34, the destination IP address 36, the source port 38, and/or the destination port 40). The EASM application 60 analyzes the source IP address 34, the destination IP address, the source port 38, and/or the destination port 40 and generates an Internet-exposed decision 64 as an output. The EASM service 50, in other words, determines whether the client device 20 faces, or is exposed to, the public Internet 24.

As FIG. 3 illustrates, the external attack surface management service (EASM) 50 may compare the connection notification 42 to an IP address scan 70. In FIG. 3, for example, the EASM service 50 maintains an electronic public IP address database 72 that logs open ports associated with devices connected to the public Internet 24 (illustrated in FIG. 2). The EASM service 50, for example, may log records describing the IP addresses and ports 34-40 associated with the server 26 connecting to the public Internet 24 (as FIG. 2 illustrated). The EASM service 50, for example, may have components or services (such as Internet surface mappers) that ping or contact as many public IP address as possible and log each response (such as the source IP address 34, the destination IP address 36, the source port 38, and/or the destination port 40) associated with every device or host on the public Internet 24. The EASM service 50, of course, may not reach every device on the Earth or in the universe, as many devices are simply not reachable for many reasons not relevant here. The EASM service 50, then, may query or contact as many hosting devices and/or public IP addresses as reasonably/feasibly possible and log each response. While the public IP address database 72 may be maintained by a networked member of the cloud computing environment 22 (illustrated in FIGS. 1-2), FIG. 3 illustrates a simple example of local hosting. The public IP address database 72 is illustrated as being locally stored in the memory device 62 of the cloud-based server 56. The EASM application 60 reads the source IP address 34, the destination IP address 36, the source port 38, and/or the destination port 40 specified by, or referenced by, the connection notification 42. The EASM application 60 then compares the source IP address 34, the destination IP address 36, the source port 38, and/or the destination port 40 to the database entries in the public IP address database 72. The public IP address database 72 includes database entries that log, map, or otherwise associate different source IP addresses 34, different destination IP addresses 36, different source ports 38, and/or different destination ports 40 discovered via the IP address scan 70 associated with the public Internet 24.

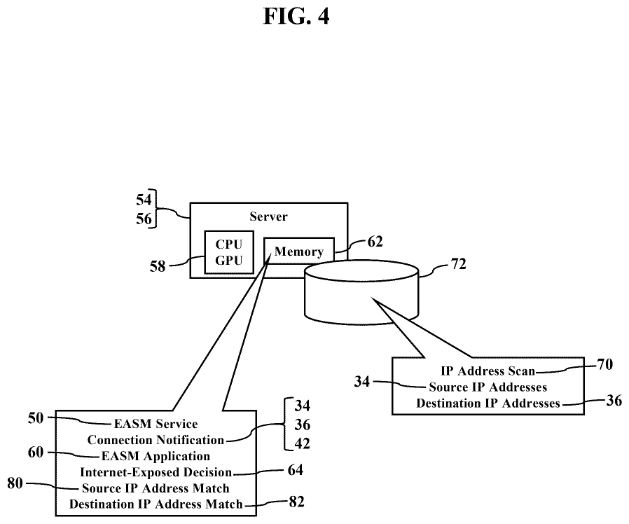

FIG. 4 illustrates examples of address matches. The external attack surface management (EASM) application 60 instructs the hardware processor 58 to compare the connection notification 42 to the IP address scan 70 (as reflected by the entries of the public IP address database 72). The EASM service 50 identifies matches between the connection notification 42 and the IP address scan 70. The EASM application 60, for example, reads and compares the source IP address 34, as specified by the connection notification 42, to the entries in the public IP address database 72 that log or record the source IP addresses 34 associated with the IP address scan 70. If the EASM application 60 determines that the source IP address 34, as specified by the connection notification 42, equals, satisfies, or matches a source IP address 34 recorded by the public IP address database 72, then the EASM application 60 determines and logs a source IP address match 80. The EASM application 60 may also read and compare the destination IP address 36, as specified by the connection notification 42, to the entries in the public IP address database 72 that log or record the destination IP addresses 36 associated with the IP address scan 70. If the EASM application 60 determines that the destination IP address 36, as specified by the connection notification 42, equals or matches the same or equivalent destination IP address 36 recorded by the public IP address database 72, then the EASM application 60 determines and logs a destination IP address match 82.

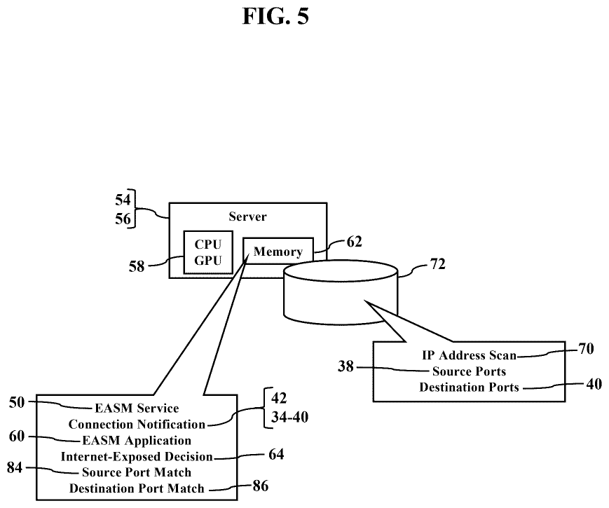

FIG. 5 illustrates examples of port matches. The external attack surface management (EASM) service 50 may compare the connection notification 42 to the IP address scan 70. The EASM service 50 may identify matches between the connection notification 42 and the IP address scan 70. The EASM application 60, for example, reads and compares the source port 38, as specified by the connection notification 42, to the entries in the public IP address database 72 that log or record the source ports 38 associated with the IP address scan 70. If the EASM application 60 determines that the source port 38, as specified by the connection notification 42, equals or matches a source port 38 recorded by the public IP address database 72, then the EASM application 60 determines and logs a source port match 84. The EASM application 60 may also read and compare the destination port 40, as specified by the connection notification 42, to the entries in the public IP address database 72 that log or record the destination ports 40 associated with the IP address scan 70. If the EASM application 60 determines that the destination port 40, as specified by the connection notification 42, equals or matches a destination port 40 recorded by the public IP address database 72, then the EASM application 60 determines and logs a destination port match 86.

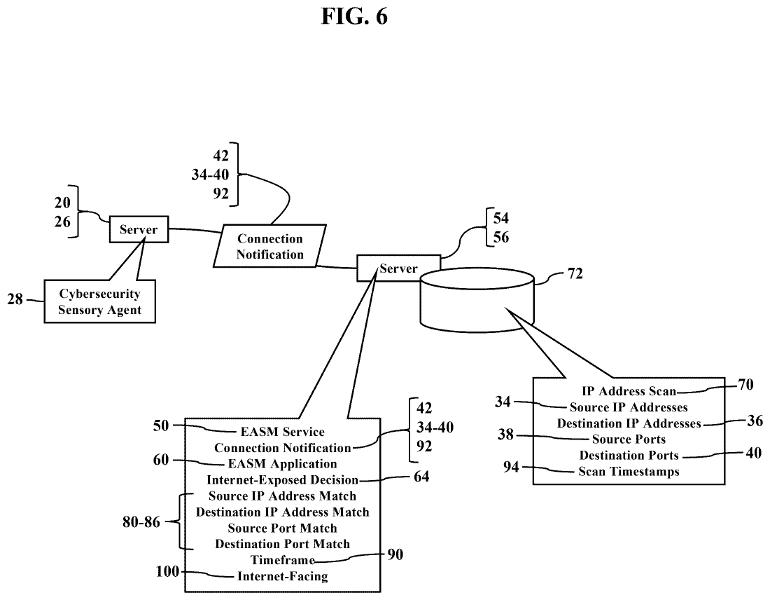

FIG. 6 illustrates examples of discovered, Internet-exposed devices. The external attack surface management (EASM) service 50 may discover Internet-exposed devices based on address matches and port matches within a timeframe 90 (e.g., seconds, minutes, or hours). When the server 56 receives the connection notification 42, the connection notification 42 may be associated with one or more connection timestamps 92. The connection notification 42, for example, may have data fields, parameters, tags, and/or metadata describing a connection timestamp 92 associated with the client device 20, the cybersecurity sensory agent 28, and/or the operating system 30 (illustrated in FIG. 1). The connection notification 42, in simple words, may be associated with a day and time. The source IP address 34, the destination IP address 36, the source port 38, and/or the destination port 40 may also be associated with the day and time connection timestamp 92. The entries in the public IP address database 72 may also be associated with one or more scan timestamps 94. The external attack surface management (or EASM) application 60 may thus identify the same source IP addresses (e.g., the source IP address match 80) having the connection timestamp(s) 92 and the scan timestamp(s) 94 that occur within the timeframe 90. The EASM application 60 may also identify the same destination IP addresses (e.g., the destination IP address match 82) having the connection timestamp(s) 92 and the scan timestamp(s) 94 that occur within the timeframe 90. The EASM application 60 may also identify the same source ports (e.g., the source port match 84) having the connection timestamp(s) 92 and the scan timestamp(s) 94 that occur within the timeframe 90. The EASM application 60 may also identify the same destination ports (e.g., the destination port match 86) having the connection timestamp(s) 92 and the scan timestamp(s) 94 that occur within the timeframe 90. When the EASM application 60 determines the source IP address match 80, the destination IP address match 82, the source port match 84, and/or the destination port match 86 commonly occurring within the timeframe 90, then the EASM application 60 identifies the corresponding client device 20 as Internet-facing 100. The client device 20, in other words, is exposed to the public Internet 24 (illustrated in FIGS. 1-2), so incoming Internet packet traffic is routable to the client device 20. The corresponding client device 20 is therefore vulnerable to a cybersecurity attack delivered via the public Internet 24.

The external attack surface management (EASM) service 50 thus identifies devices that are exposed to the public Internet 24. The external attack surface management service maintains a periodic partial, reasonable, and/or feasible scan of Internet Protocol (or IP) addresses associated with the public Internet (e.g., the IP address scan 70). The external attack surface management service 50 thus maintains a complete database of the open ports on every IPv4 or IPv6 host on the public Internet 24. Each database record thus documents the source IP address 34, the destination IP address 36, the source port 38, the destination port 40, and the scan timestamp(s) 94. The external attack surface management (or EASM) application 60 correlates event criteria (such as the source IP address match 80, the destination IP address match 82, the source port match 84, and/or the destination port match 86) that occur within the timeframe 90 to identify and classify the corresponding client device 20 as the Internet-facing 100. The EASM application 60 thus reveals the public IP address (such as the either or both of the source IP address 34 and the destination IP address 36) and the listening port (such as the either or both of the source port 38 and the destination port 40) associated with the cybersecurity sensory agent 28 and the hosting client device 20. The external attack surface management service 50 thus identifies computer assets that are directly exposed to the public Internet 24. The external attack surface management service 50, however, also identifies computer assets that are networked behind a layer 3 or 4 network address table (where the source and/or destination Internet IP addresses is/are preserved).

The timeframe 90 may be configurable. While the timeframe 90 may have a length, interval, or start/stop time from an initial value (e.g., seconds, minutes, hours, or longer), the timeframe 90, for example, may be thirty minutes (30 minutes) to account for clock skew. The client device 20 and the server 56, for example, may have differing internal, master, and/or network clocks, so the 30 minute timeframe 90 may account for clock skew. The external attack surface management service 50 may be configured to use the timeframe 90 best suited to network conditions. The external attack surface management (or EASM) application 60 identifies the Internet-facing 100 client device 20 based on the event criteria (such as the source IP address match 80, the destination IP address match 82, the source port match 84, and/or the destination port match 86) having the having the connection timestamp(s) 92 and the scan timestamp(s) 94 that occur within the timeframe 90. The connection timestamp(s) 92 may precede or follow the scan timestamp(s) 94, as along as a time difference lies within the timeframe 90.

The external attack surface management (EASM) service 50 may merge different datasets. The external attack surface management service 50, for example, may employ computer systems (or scanners) that perform the IP address scan 70 and that log the results in the public IP address database 72. The external attack surface management service 50 also employs the cybersecurity sensory agent 28 that monitors the client device 20 operating in the field. When the cybersecurity sensory agent 28 detects a TCP, UDP, or other communications request, the cybersecurity sensory agent 28 causes the client device 20 to send the connection notification 42. The external attack surface management service 50 may thus merge and compare the connection notification 42 to the IP address scan(s) 70 logged by the public IP address database 72. The external attack surface management service 50 then identifies actual attributions (e.g., the address and/or port matches 80-86) that occur between the datasets.

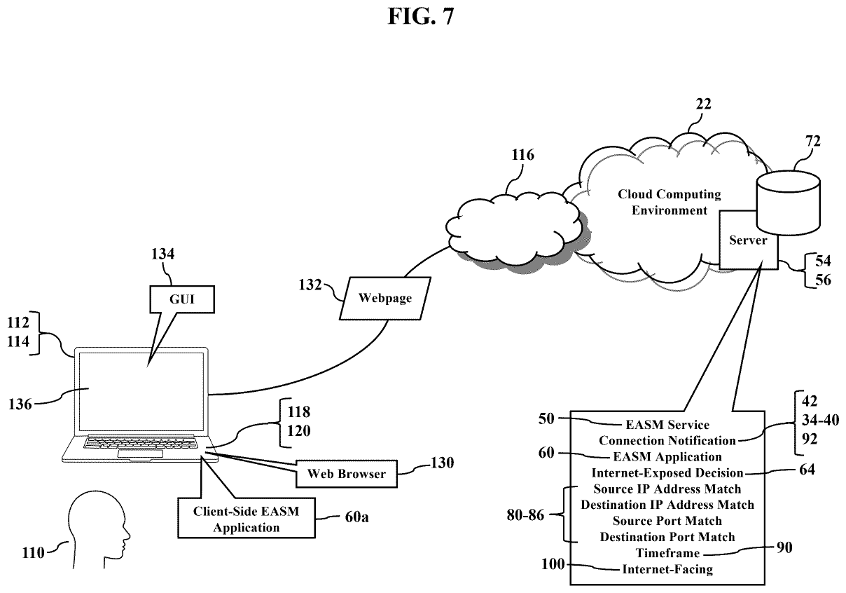

FIG. 7 illustrates examples of web interfacing. The external attack surface management (or EASM) service 50 may have a user/web interface that allows user interaction and feedback. FIG. 7 thus illustrates remote access to the external attack surface management service 50. A human user 110 (such as an expert cybersecurity analyst), for example, may use an analyst's computer 112 to interface with the server 56. FIG. 7 illustrates the analyst's computer 112 as a remote laptop computer 114, but the analyst's computer 112 may be a smartphone, tablet, server, or other computer system. The analyst's computer 112 has a network interface to an access network or other communications network 116 (such as the public Internet 24), thus allowing the analyst's computer 112 to establish network communications with the cloud computing environment 22 and/or with the server 56. The analyst's computer 112 may thus have access permissions to the cloud computing environment 22 and/or to the server 56. The analyst's computer 112 has a hardware processor 118 that executes a client-side version 60a of the external attack surface management (or EASM) application stored in a memory device 120. The EASM application 60 and the client-side version 60a may cooperate in a client-server relationship to facilitate a human analyst review of the IP address scan 70, the public IP address database 72, the connection notification 42, and/or the EASM service 50.

The analyst's computer 112 stores and executes a web browser 130 that interfaces with the client-side version 60a of the EASM application 60. When the human user 110 wishes to review the EASM service 50, the human user 110 commands the client-side version 60a of the EASM application to establish communication with the server 56. The human user 110, in particular, may access service records associated with the EASM service 50. The web browser 130 and the client-side version 60a cooperate to request and to receive a webpage 132 having content representing the IP address scan 70, the public IP address database 72, the connection notification 42, the Internet-exposed decision 64, the matches 80-86, and other service records associated with the EASM service 50. The analyst's computer 112 processes and displays the webpage 132 as a dashboard or other graphical user interface (GUI) 134 via a display device 136. The human user 110 may thus scrutinize the service records and the Internet-exposed decision 64 determined by the EASM service 50. The human user 110 may even approve or override any classification as the Internet-facing 100.

The external attack surface management (EASM) service 50 thus implements an elegant solution. The EASM service 50 automatically scans every single IP address allocated to the public Internet 24 (24 hours a day, 7 days a week), perhaps on a fixed number of ports, where a network connection might be made. The results of the IP address scan 70 are collected by the cloud computing environment 22 and recorded to the public IP address database 72. Moreover, every host client device 20 running the cybersecurity sensory agent 28 (as illustrated by FIG. 6) is listening for all inbound connections (such as from the public Internet 24 and from inside a private intranet). So, when any device on the public Internet 24 “knocks on the door” of the client device 20 (such as a connection request), the cybersecurity sensory agent 28 reports a record of the requested or established connection to the cloud computing environment 22 (via the connection notification 42). The EASM service 50 compares these records and looks for matches (such as the source IP address match 80, the destination IP address match 82, the source port match 84, and/or the destination port match 86 that occur within the timeframe 90). The EASM service 50, for example, identifies one or more data packets sent from a host on the Internet with a source and destination port that match an accepted connection from an IP address with the same port combination at a timestamp. A match between these four (4) event criteria (such as the matches 80-86) that occur within the timeframe 90 reveals the cybersecurity sensory agent 28 that is exposed to the public Internet 24 by the public IP address on the port. The human user 110 may enter search criteria via the webpage/GUI 132/134 and filter the service records according to any query or search parameter.

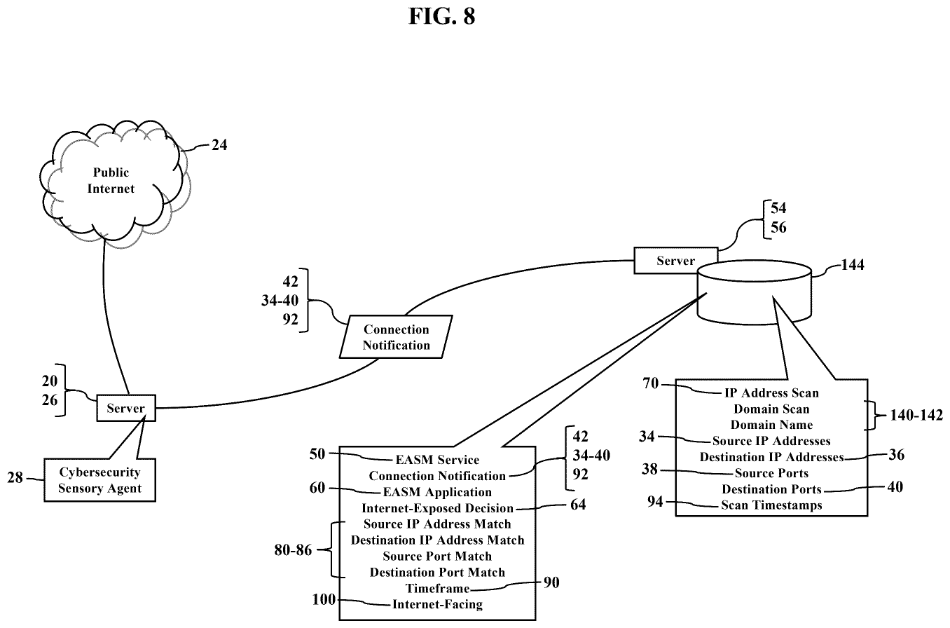

FIG. 8 illustrates more examples of discovered Internet-exposed devices. The external attack surface management (EASM) service 50 may utilize other decisional schemes to identify the client devices 20 that are exposed to the public Internet 24. Even though the EASM service 50 conducts the IP address scan 70 of all the Internet Protocol (or IP) addresses associated with the public Internet, some source and/or destination Internet IP addresses are not preserved. That is, some layer 3/4 NAT may lack entries or fail to preserve the source and/or destination Internet IP addresses 34 and 42. The external attack surface management (EASM) service 50 may thus utilize other mechanisms to identify the client devices 20 that are exposed to the public Internet 24. The EASM application 60, for example, may execute logical statements or rules that correlate event criteria based on the timestamps 92 and 94, the source port 38, the destination port 40, and Internet Protocol (IP) addresses (such as the source IP address 34 and/or the destination IP address 36) that are a part of a specific entity's or customer's digital footprint. As an example, the EASM service 50 may confine the IP address scan 70 to a domain scan 140 of network addresses associated with a domain name 142. Suppose, for example, that the EASM service 50 determines which hosts, associated with a customer's website domain www.customerdomain.com, are the Internet-facing 100 and exposed to the public Internet 24. The EASM service 50 may thus restrict or limit the IP address scan 70 to only the IP addresses associated with the customer's website domain www.customerdomain.com. The EASM service 50 may thus only scan the open ports on every IPv4 or IPv6 host associated with the customer's website domain www.customerdomain.com. The EASM service 50 may also maintain an electronic customer domain IP address database 144 that logs each and every open port on every host associated with the customer's website domain www.customerdomain.com. The external attack surface management service 50, in other words, may ping or contact every IP address associated with the customer's website domain and log each response (such as the source IP address 34, the destination IP address 36, the source port 38, and/or the destination port 40) along with the scan timestamp 94.

The EASM service 50 may discover Internet-exposed devices based on address matches and port matches within the timeframe 90 (e.g., seconds, minutes, or hours). When the server 56 receives the connection notification(s) 28, the EASM service 50, for example, may identify the source port match 84, the destination port match 86, and/or the Internet Protocol (IP) address match 80 and/or 82 that occur within the timeframe 90 between the connection notification 42 and the domain scan 140 of the network addresses associated with the domain name 142 (e.g., www.customerdomain.com). Whenever the EASM application 60 determines the source port match 84, the destination port match 86, and/or the Internet Protocol (IP) address match 80 and/or 82 within the timeframe 90, the EASM application 60 identifies and/or classifies the corresponding client device 20 as the Internet-facing 100. The EASM application 60 thus reveals the public IP address (such as the either or both of the source IP address 34 and the destination IP address 36) and the listening port (such as the either or both of the source port 38 and the destination port 40) associated with the cybersecurity sensory agent 28 and the hosting client device 20. So, the external attack surface management service 50 still identifies computer assets that are directly exposed to the public Internet 24, even though some source and/or destination Internet IP addresses may not be preserved (such as by a NAT conversion).

The EASM service 50 greatly improves computer functioning. The external attack surface management (EASM) service 50 identifies computer assets (such as the client device 20) that are exposed to the public Internet 24 and are thus vulnerable to the cybersecurity attacks. The IP address scan 70 of all the Internet Protocol (or IP) addresses associated with the public Internet 24, however, may require contacting/pinging/synching about 180 million-million IP addresses. By limiting the IP address scan 70, however, to only the domain scan 140 of the customer's website domain name 142 (e.g., www.customerdomain.com), the number or volume of the IP addresses dramatically reduces to only hundreds or thousands at a maximum. Simply put, the customer's website domain name 142 has far less IP addresses that must be scanned. The server's hardware processor 58 thus requires far less cycles to determine the Internet-facing 100 asset, and the domain scan 140 consumes far less memory bytes in the server's memory device 62. The server 56 also consumes much less electrical power to identify the Internet-facing 100 asset. The EASM service 50 again greatly improves computer functioning.

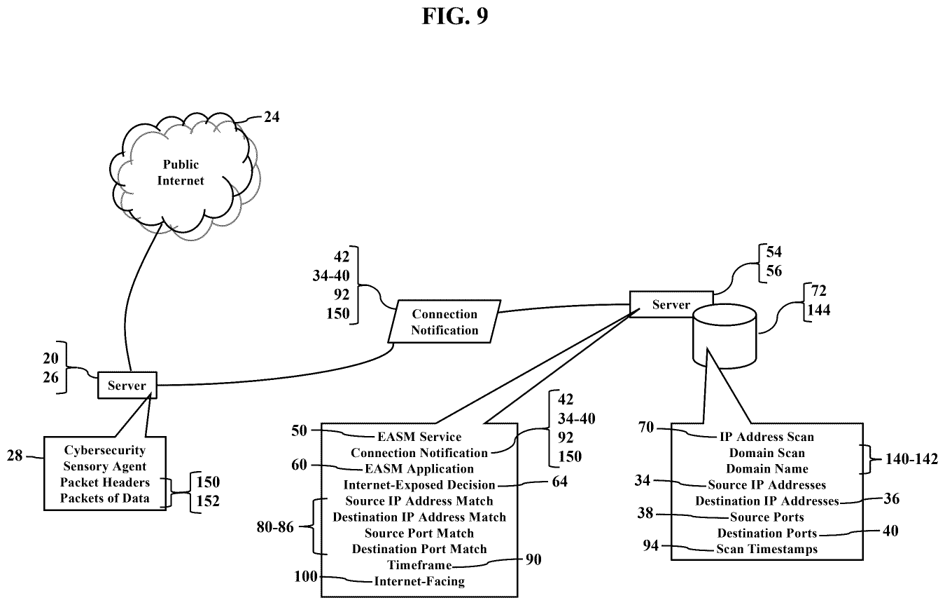

FIG. 9 illustrates examples of packet capture for discovering Internet-exposed devices. The external attack surface management (EASM) service 50 may utilize still more decisional schemes to identify the client devices 20 that are the Internet-facing 100 and thus exposed to the public Internet 24. The cybersecurity sensory agent 28, for example, may capture and forward packet headers 150 associated with packets 152 of data. The packet headers 150 may contain fields or values that reveal the source (perhaps even the origin or original) Internet Protocol (or IP) address 34, the destination IP address 36, the source port 38, and/or the destination port 40 associated with a network communication. When the cybersecurity sensory agent 28 cooperates with the operating system 30 (illustrated in FIG. 1) to generate and report the connection notification 42, the connection notification 42 may have electronic content representing the packet headers 150 (and/or the packets 152 of data) associated with a requested or established network communication (such as, for example, the source IP address 34, the destination IP address 36, the source port 38, and/or the destination port 40). The cybersecurity sensory agent 28, as another example, may forward the packet headers 150 to the cloud computing environment 22. When the server 56 receives the connection notification 42, and/or the packet headers 150, the EASM application 60 may compare the connection notification 42 and/or the packet headers 150 to the IP address scan 70 and/or to the domain scan 140. The EASM application 60 may identify the source IP address match 80 having the connection timestamp(s) 92 and the scan timestamp(s) 94 that occur within the timeframe 90. The EASM application 60 may additionally or alternatively identify the destination IP address match 82, the source port match 84, and/or the destination port match 86 that occur(s) within the timeframe 90. The EASM application 60 may thus classify the corresponding client device 20 as the Internet-facing 100 based on the packet headers 150 used to identify the source IP address match 80, the destination IP address match 82, the source port match 84, and/or the destination port match 86 that occur(s) within the timeframe 90. The packet headers 150 may thus be used to identify the client device 20 that is exposed to the public Internet and receiving incoming Internet packet traffic. The corresponding client device 20 is therefore vulnerable to the cybersecurity attack.

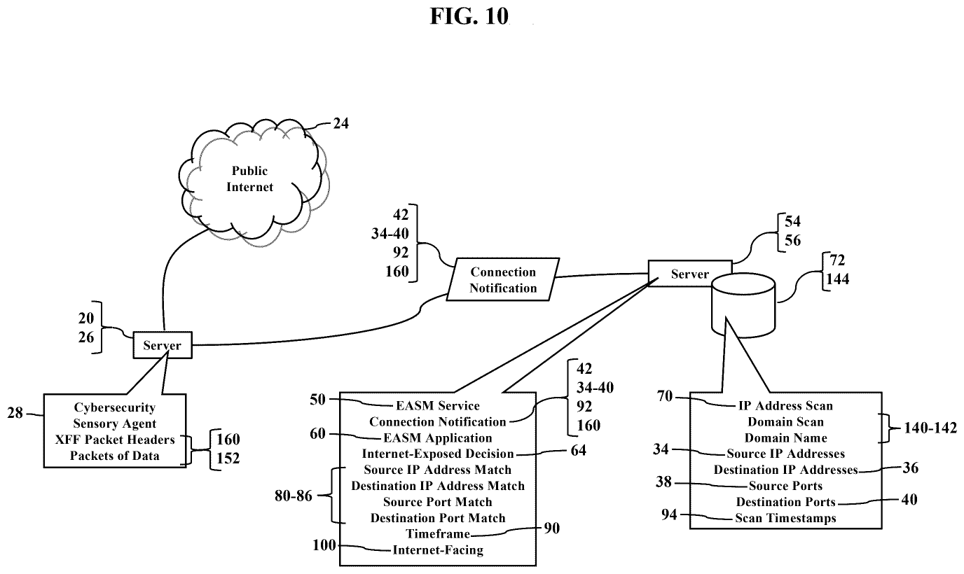

FIG. 10 illustrates more examples of packet capture for discovering Internet-exposed devices. The external attack surface management (EASM) service 50 may utilize still more decisional schemes to identify the client devices 20 that are the Internet-facing 100 and thus exposed to the public Internet 24. The cybersecurity sensory agent 28, for example, may capture and forward X-Forwarded-For (or XFF) packet headers 160 associated with HTTP requests and HTTP responses. The X-Forwarded-For packet headers 160 preserve and identify Internet Protocol (or IP) addresses, even when network communications involve intermediate or intercepting proxy servers and/or load balancers. The X-Forwarded-For packets headers 160, for example, may preserve and identify the source IP address 34, the destination IP address 36, the source port 38, and/or the destination port 40. When the cybersecurity sensory agent 28 cooperates with the operating system 30 (illustrated in FIG. 1) to generate and report the connection notification 42, the connection notification 42 may have electronic content representing the X-Forwarded-For packets headers 160 associated with packetized HTTP requests and HTTP responses. The cybersecurity sensory agent 28, as another example, may forward the X-Forwarded-For packets headers 160 to the cloud computing environment 22. When the server 56 receives the connection notification 42, and/or the X-Forwarded-For packets headers 160, the EASM application 60 may compare the connection notification 42 and/or the X-Forwarded-For packets headers 160 to the IP address scan 70 and/or to the domain scan 140. The EASM application 60 may identify the source IP address match 80 having the connection timestamp(s) 92 and the scan timestamp(s) 94 that occur within the timeframe 90. The EASM application 60 may additionally or alternatively identify the destination IP address match 82, the source port match 84, and/or the destination port match 86 that occur(s) within the timeframe 90. The EASM application 60 may thus classify the corresponding client device 20 as the Internet-facing 100 based on the X-Forwarded-For packets headers 160 used to identify the source IP address match 80, the destination IP address match 82, the source port match 84, and/or the destination port match 86 that occur(s) within the timeframe 90. The X-Forwarded-For packets headers 160 may thus be used to identify the client device 20 that is exposed to the public Internet 24 and receiving incoming Internet packet traffic. The corresponding client device 20 is therefore vulnerable to the cybersecurity attack.

The EASM service 50 further improves computer functioning. The external attack surface management (EASM) service 50 correlates Internet exposure with the source IP address match 80, the destination IP address match 82, the source port match 84, and/or the destination port match 86 with the timestamps 92 and 94 occurring within the timeframe 90. The EASM service 50 thus uses these internal traffic data addresses and ports to discover and to identify computer assets (such as the client device 20) that are exposed to the public Internet. Simply put, the EASM service 50 reveals client devices 20 that may have their processor, memory, and software resources harmed by cybersecurity attacks.

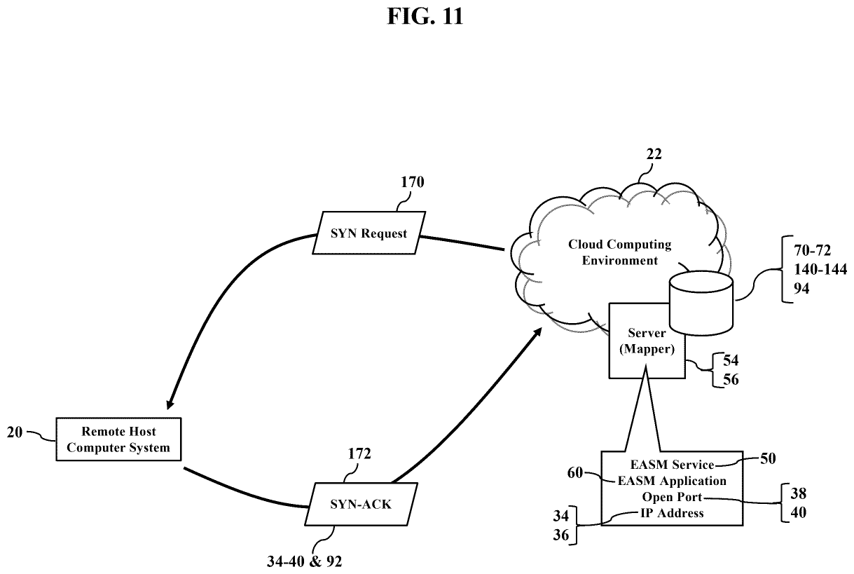

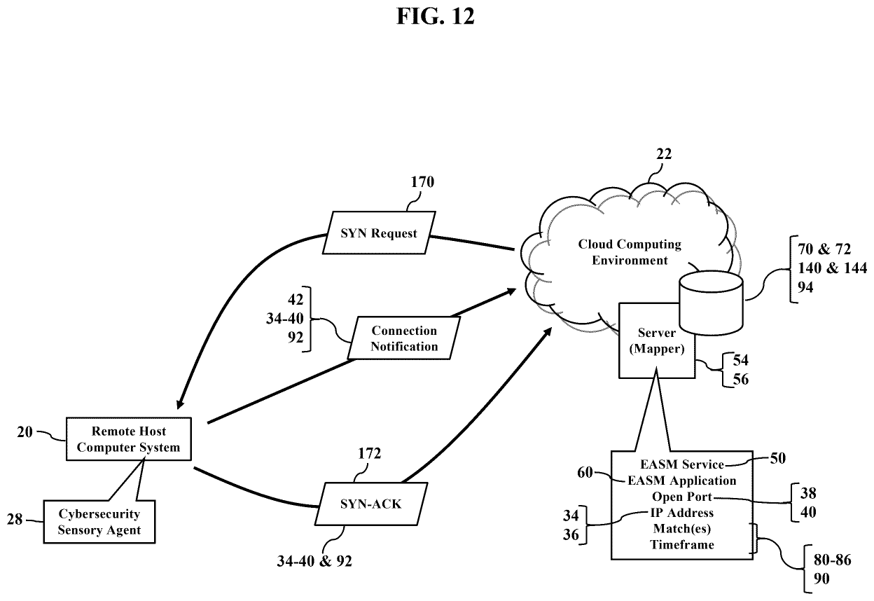

FIGS. 11-12 illustrate examples of IP address scanning and correlation. The cloud computing environment 22 may conduct the IP address scan 70, and/or the domain scan 140, using a message and response mechanism. The cloud computing environment 22, for example, sends a message to an Internet Protocol (IP) address via the public Internet 24 and/or via the customer's website domain name 142 (e.g., www.customerdomain.com) (not illustrated, but as previously explained). The cloud computing environment 22, in other words, may ping or contact the IP address and then monitor for a response. While any networked member 26 of the cloud computing environment 22 may conduct the IP address scan 70 and/or the domain scan 140, FIG. 11 illustrates a simple example using the server 56. The external attack surface management (EASM) application 60 instructs or causes the server 56 to participate in a handshake mechanism to establish network communication with a remote host (such as the client device 20). FIG. 11, for example, illustrates a synchronize (or SYN) message 170 from the server 56 (perhaps functioning as a surface mapper) to an IP address associated with the client device 20. If the client device 20 receives the SYN message 170, the client device 20 responds with a synchronize-acknowledge (or SYN-ACK) message 172. When the server 56 receives the SYN-ACK message 172, the EASM application 60 inspects the content of the SYN-ACK message 172 and determines the IP address and open port (e.g., the source IP address 34, the destination IP address 36, the source port 38, and/or the destination port 40). The EASM application 60 may then add one or more database entries to the databases 72 and/or 144 that record and log the scan results. FIG. 12, as another example, illustrates the cybersecurity sensory agent 28 hosted by the remote host (such as the client device 20). The server 56 (e.g., the surface mapper) sends the SYN message 170 to the IP address associated with the client device 20. Because the client device 20 stores and executes the cybersecurity sensory agent 28, the cybersecurity sensory agent 28 may generate and send the connection notification 42. The connection notification 42 notifies the cloud computing environment 22 that the SYN message 170 has been received. The connection notification 42, for example, may further notify of the IP address and port (e.g., the source IP address 34, the destination IP address 36, the source port 38, and/or the destination port 40). The client device 20, and/or the cybersecurity sensory agent 28, may then respond with the synchronize-acknowledge (or SYN-ACK) message 172. When the server 56 receives the SYN-ACK message 172, the EASM application 60 inspects the content of the SYN-ACK message 172 and determines the IP address and open port (e.g., the source IP address 34, the destination IP address 36, the source port 38, and/or the destination port 40). FIG. 12 thus illustrates correlation according to address, port, and time. The external attack surface management (EASM) service 50 correlates Internet exposure with the source IP address match 80, the destination IP address match 82, the source port match 84, and/or the destination port match 86 with the timestamps 92 and 94 occurring within the timeframe 90.

The external attack surface management (EASM) service 50 may thus scan and map IP addresses. The EASM service 50 may conduct the IP address scan 70 by automatically scanning every single IP address allocated to the public Internet 24, 24 hours a day, 7 days a week. The results of the IP address scan 70 are collected by the cloud computing environment 22 and recorded to the public IP address database 72. As a simple example, in the IPV4 scheme, SYN messages 170 may be sent to class A addresses (IP Range: 1.0.0.0 to 127.0.0.0), class B addresses (128.0.0.0 to 191.255.0.0), and to class C addresses (192.0.0.0 to 223.255.255.0). The EASM service 50, however, may additionally or alternatively conduct the domain scan 140 of the network addresses associated with the domain name 142 (such as the customer's website domain www.customerdomain.com). The EASM service 50 may thus only scan the open ports on every IPv4 or IPv6 host associated with the customer's website domain. The EASM service 50 may thus collect and record the scan results to the customer domain IP address database 144. The EASM service 50 may then identify the client device 20 as the Internet-facing based on the source IP address match 80, the destination IP address match 82, the source port match 84, and/or the destination port match 86 that occur(s) within the timeframe 90.

The EASM service 50 further improves computer functioning. Exposed endpoints (such as the client device 20) accessed from the Internet are low hanging fruit for threat actors. Attackers are continuously scanning the Internet to find the most vulnerable exposed devices. The external attack surface management (EASM) service 50 allows users, customers, and organizations to prioritize their cybersecurity risk by exposing the Internet-facing 100 client devices 20 that are vulnerable to cybersecurity attacks. The Internet-facing 100 client devices 20 are quickly revealed for immediate cybersecurity remediation. Cybersecurity and IT teams may further quickly identify and resolve misconfigurations that reduce cybersecurity attacks.

The EASM service 50 provides even more improved computer functioning. When the external attack surface management (EASM) service 50 discovers Internet-exposed computer assets, the EASM service 50 may also identify a responsible cybersecurity and/or IT team and/or personnel. In today's hosted computing environment, cloud services and applications may be unknowingly hosted on computer servers throughout the world. By pairing complete scanning of the IPV4/6 Internet space with records of accepted TCP, UDP, network connections from the cybersecurity sensory agents 32 running on the hosting client devices 20, an inside out and outside in view of the host can be built. This makes identification of asset owners much easier. Because every installation of the cybersecurity sensory agent 28 has a unique identifier, identifying the specific host is easy and useful. The cybersecurity sensory agent 28 may further add helpful metadata about the host, including the MAC address, hostname, and local domain, all of which can be used to identify the asset owner in the service records of the EASM service 50. The EASM service 50 may further mark assets using the cybersecurity sensory agent 28 with tags that can further point to the owner of an asset.

The external attack surface management (EASM) service 50 discovers Internet-exposed computer assets. The EASM service 50 exposes the Internet-facing 100 computer assets that are vulnerable to the cybersecurity attacks. Because the EASM service 50 has a web interface (such as the webpage 132 and the client-side version 60a of the EASM application), the user 110 (such as the human expert cybersecurity analyst) may thus access the EASM service 50 (such as via the analyst's computer 112) and inspect the IP addresses 34/42, the ports 38/46, the client devices 20, and/or the Internet-exposed decisions 60 that are the Internet-facing 100 and reachable via the public Internet 24. The EASM service 50 may further reveal the endpoint cybersecurity sensory agents 32 hosted by the client devices 20 that are the Internet-facing 100 and reachable via the public Internet 24. The EASM service 50 may thus be integrated into EDR/XDR/MDR monitoring platforms and user interfaces (such as the GUI 134 explained with reference to FIG. 7). The human user 110 may thus scrutinize the service records and the Internet-exposed decisions 60 associated with the client devices 20. The human user 110 may even approve or override any classification of the client device 20 as the Internet-facing 100.

The external attack surface management (EASM) service 50 may also suggest countermeasures. The public IP address database 72, and the customer's domain IP address database 144, is/are rich repositories of very accurate Internet addressing and cybersecurity records. The EASM service 50, then, may inspect these current and historical cybersecurity service records and recommend, or suggest, configurational remediations associated with the Internet-exposed decisions 60. The EASM service 50, for example, may search, identify, and/or retrieve historical remediations implemented at other client devices 20 to resolve their Internet-facing 100 determinations. The EASM service 50 may then generate and display a recommendation (perhaps via the webpage 132) to similarly remediate a mis-configured client device 20. Indeed, the EASM service 50 may interface with the endpoint cybersecurity sensory agent 28 (hosted by the mis-configured client device 20) to automatically implement a remedial setting, parameter, configuration, or other resolution. The EASM service 50, in other words, may instruct the endpoint cybersecurity sensory agent 28 (perhaps via remedial configuration settings sent to the IP address associated with the Internet-facing 100 client device 20) to interface with the operating system 30 and to resolve the Internet-exposed decision 64. The EASM service 50 may thus be an automated solution that reduces or eliminates the cybersecurity attacks.

The external attack surface management (EASM) service 50 may also have customer interfaces. The EASM service 50 may have a customer-facing interface (such as the GUI 134 illustrated in FIG. 7) that is tailored to corporate, small business, individuals, and other customers. The EASM service 50 may thus allow customers to reveal their Internet-facing 100 client devices 20.

Computer functioning is again improved. Internet exposure makes computer operations vulnerable to the cybersecurity attacks. The endpoint cybersecurity sensory agent 28 and/or the EASM service 50, however, quickly identifies the client devices 20 that are the Internet-facing 100. The EASM service 50 thus identifies attack vulnerabilities and minimizes threat opportunities and damages to the client devices 20. Because the EASM service 50 maintains complete records of the entire Internet 62, and of the customer's domain name 142, the EASM service 50 is very fast and very simple to execute. The server 56, for example, need merely retrieve and compare service records in perhaps seconds. The EASM application 60, and/or the endpoint cybersecurity sensory agent 28, consume(s) little space (in bits/bytes) in the memory device 62. Moreover, the hardware processor 58 requires less cycles and less time to classify the Internet-facing 100 client device 20. Computer resources are reduced, and less electrical power is required to test for the Internet-facing 100 client device 20. The cloud-based EASM service 50 is thus very fast and very simple, allowing the server 56 to quickly assess thousands or millions of connection notifications 28 reported each week. The cloud-based EASM service 50 thus greatly improves computer functioning of the server 56 for detecting vulnerable Internet-facing 100 client devices 20.

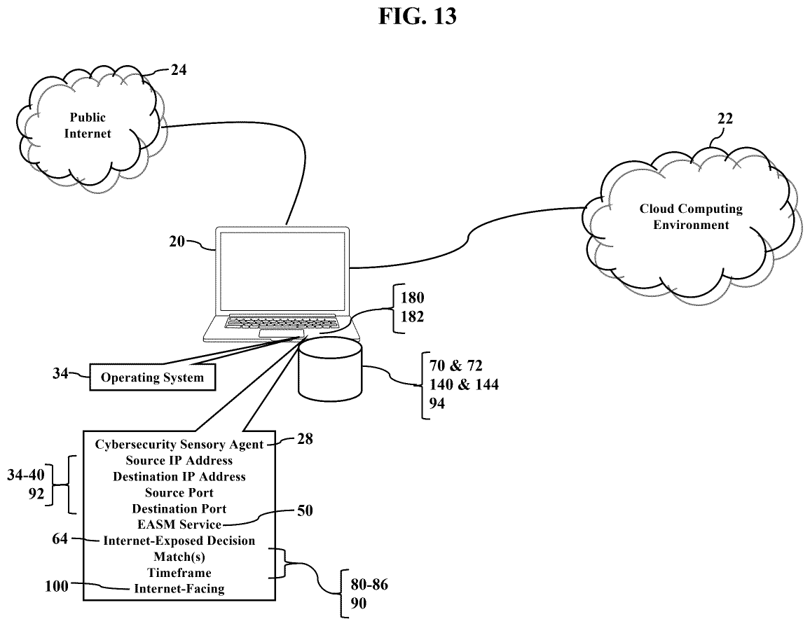

FIG. 13 illustrates some examples of local assessment. When the endpoint cybersecurity sensory agent 28 (installed to the client device 20, such as a laptop computer) detects that the client device 20 has accepted a communications request via a communication network, the cybersecurity sensory agent 28 may locally assess whether the client device 20 has the Internet-facing 100 classification. The endpoint cybersecurity sensory agent 28, in other words, may locally conduct and provide the EASM service 50 with little, or no, reliance on the cloud computing environment 22. The cybersecurity sensory agent 28, for example, is stored in a memory device 180 and executed by a hardware processor (CPU or GPU) 182. The cybersecurity sensory agent 28 cooperates with the operating system 30 and acquires the source Internet Protocol (or IP) address 34, the destination IP address 36, the source port 38, and/or the destination port 40 associated with the network communication. The cybersecurity sensory agent 28 may further include software programming, code, or instructions that locally compare the source IP address 34, the destination IP address 36, the source port 38, and/or the destination port 40 to the IP address scan 70 and/or to the domain scan 140 of the network addresses associated with the domain name 142. The client device 20, for example, may locally store the public IP address database 72 in the memory device 180. The client device 20, as another example, may additionally or alternatively locally store the customer's domain IP address database 144 in the memory device 180. So, when the cybersecurity sensory agent 28 determines the source IP address 34, the destination IP address 36, the source port 38, and/or the destination port 40, the cybersecurity sensory agent 28 may compare those addresses and/or ports to the entries in the public IP address database 72 and/or in the domain IP address database 144. When the cybersecurity sensory agent 28 determines one or more of the source IP address match 80, the destination IP address match 82, the source port match 84, and/or the destination port match 86 commonly occurring within the timeframe 90, then the cybersecurity sensory agent 28 may identify its host (e.g., the client device 20) as the Internet-facing 100. The cybersecurity sensory agent 28, in other words, may generate the Internet-exposed decision 64 as an output. The cybersecurity sensory agent 28 may thus locally self-determine whether the client device 20 faces, or is exposed to, the public Internet 24 and vulnerable to the cybersecurity attack.

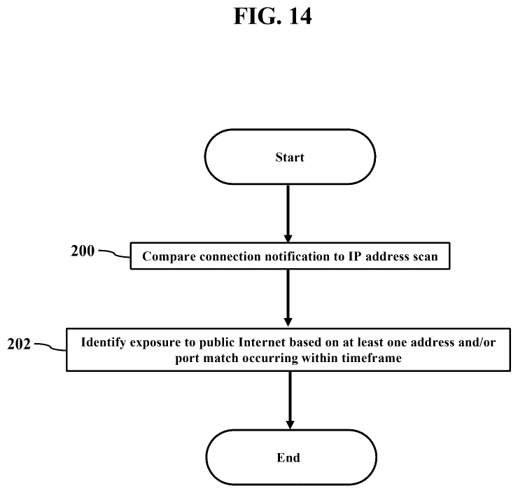

FIG. 14 illustrates examples of a method or operations that identify the client device 20 exposed to the public Internet 24. The computer system 54, providing the external attack surface management (EASM) service 50, compares the connection notification 42 reported via the cloud computing environment 22 by the cybersecurity sensory agent 28 to the IP address scan 70 of the network addresses associated with the public Internet 24 (Block 200). The computer system 54 identifies the client device 20 exposed to the public Internet 24 based on at least one of the matches 80-86 occurring within the timeframe 90 between the connection notification 42 and the IP address scan 70 (Block 202).

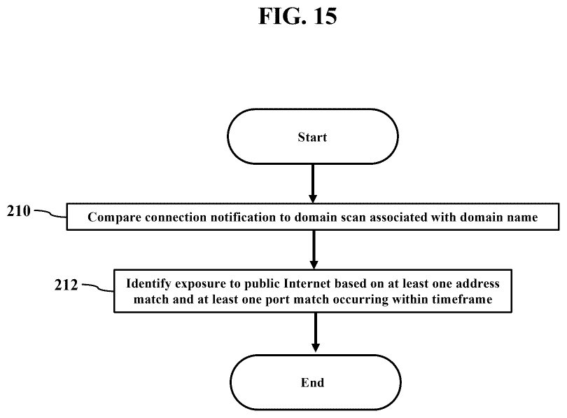

FIG. 15 illustrates more examples of a method or operations that identify the client device 20 exposed to the public Internet 24. The connection notification 42, reported to the external attack surface management (EASM) service 50 by the cybersecurity sensory agent 28 via the cloud computing environment 22, is compared to the domain scan 140 of the network addresses associated with the domain name 142 (Block 210). The client device 20 is identified as exposed to the public Internet 24 based on at least one of the address matches 80 and 82 and at least one of the port matches 84 and 86 occurring within the timeframe 90 between the connection notification 42 and the domain scan 140 (Block 212).

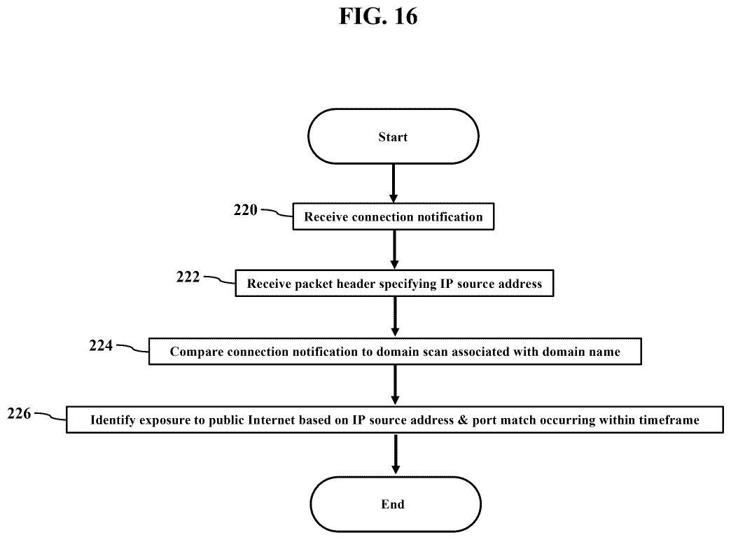

FIG. 16 illustrates still more examples of a method or operations that identify the client device 20 exposed to the public Internet 24. The connection notification 42, reported by the cybersecurity sensory agent 28 via the cloud computing environment 22 to the external attack surface management (EASM) service 50, is received (Block 220). The packet header 150 and/or 160 is received that specifies the source network address 80 (Block 222). The connection notification 42 is compared to the domain scan 140 of the network addresses associated with the domain name 142 (Block 224). The client device 20 is identified as exposed to the public Internet 24 based on the source network address 80 and a port match 84 and/or 86 occurring within the timeframe 90 between the connection notification 42 and the domain scan 140 (Block 226).

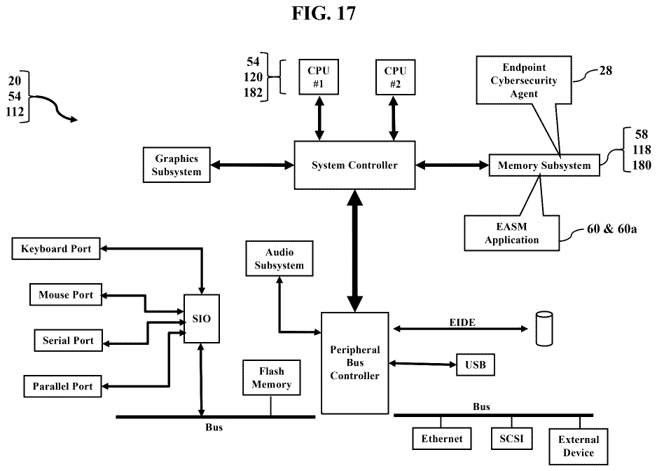

FIG. 17 illustrates a more detailed example of the operating environment. FIG. 17 is a more detailed block diagram illustrating the computer system 54, the client device 20, and/or the analyst's computer 112. The EASM application 60, the client-side version 60a of the EASM application, and/or the endpoint cybersecurity sensory agent 28, is stored in the memory subsystem or device 62/118/180. One or more of the hardware processors 58/120/182 communicate with the memory subsystem or device 62/118/180 and execute the EASM application 60, the client-side version 60a of the EASM application, and/or the endpoint cybersecurity sensory agent 28. Examples of the memory subsystem or device 62/118/180 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. Because the computer system 54, the client device 20, and/or the analyst's computer 112 is known to those of ordinary skill in the art, no detailed explanation is needed.

The computer system 54, the client device 20, and/or the analyst's computer 112 may have any embodiment. This disclosure mostly discusses the computer system 54 as the server 56. The EASM service 50, however, may be easily adapted to any stationary or mobile computing, such as a desktop computer, a laptop computer, a tablet computer, a smartwatch, and a network switch/router. The EASM service 50 may also be easily adapted to other embodiments of smart devices, such as a television, an audio device, a remote control, and a recorder. The EASM service 50 may also be easily adapted to still more smart appliances, such as washers, dryers, and refrigerators. Indeed, as cars, trucks, and other vehicles grow in electronic usage and in processing power, the EASM service 50 may be easily incorporated into any vehicular controller.

The above examples of the EASM service 50 may be applied regardless of the networking environment. The EASM service 50 may be easily adapted to stationary or mobile devices having wide-area networking (e.g., 4G/LTE/5G/6G/7G cellular), wireless local area networking (WI-FI®), near field, and/or BLUETOOTH® capability. The EASM service 50 may be applied to stationary or mobile devices utilizing any portion of the electromagnetic spectrum and a signaling standard (such as the IEEE 802 family of standards, GSM/CDMA/TDMA or other cellular standard, and/or the ISM band). The EASM service 50, however, may be applied to any processor-controlled device operating in the radio-frequency domain and/or the Internet Protocol (IP) domain. The EASM service 50 may be applied to any processor-controlled device utilizing a distributed computing network, such as the Internet (sometimes alternatively known as the “World Wide Web”), an intranet, a local-area network (LAN), and/or a wide-area network (WAN). The EASM service 50 may be applied to any processor-controlled device utilizing power line technologies, in which signals are communicated via electrical wiring. Indeed, the many examples may be applied regardless of physical componentry, physical configuration, or communications standard(s).

The EASM service 50 may utilize a processing component, configuration, or system. For example, the EASM service 50 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The EASM service 50 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The EASM service 50 may use packetized communications. When the computer system 54, the client device 20, and/or the analyst's computer 112 communicates communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The EASM service 50 may utilize a signaling standard. The computer system 54, the client device 20, and/or the analyst's computer 112, and/or the cloud computing environment 22 may mostly use wired networks to interconnect network members. However, the computer system 54, the client device 20, and/or the analyst's computer 112, and the cloud computing environment 22 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The EASM service 50 may also utilize other standards, such as the I.E.E.E. 802 family of standards, the Industrial, Scientific, and Medical band of the electromagnetic spectrum, BLUETOOTH®, low-power or near-field, and other standard or value.

The EASM service 50 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for identifying Internet-exposed devices, as the above paragraphs explain.

The diagrams, schematics, illustrations, and the like represent conceptual views or processes illustrating examples of cybersecurity command line assessment. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that identifies a device exposed to a public Internet, comprising:
comparing, by the computer system providing an external attack surface management service, a connection notification reported via a cloud computing environment by a cybersecurity sensory agent to a scan of network addresses associated with the public Internet; and
identifying, by the computer system providing the external attack surface management service, the device exposed to the public Internet based on a match occurring within a timeframe between the connection notification and the scan of the network addresses associated with the public Internet.

2. The method of claim 1, wherein the identifying of the device exposed to the public Internet based on the match further comprises determining a source network address specified by both the connection notification and the scan of the network addresses associated with the public Internet.

3. The method of claim 1, wherein the identifying of the device exposed to the public Internet based on the match further comprises determining a destination network address specified by both the connection notification and the scan of the network addresses associated with the public Internet.

4. The method of claim 1, wherein the identifying of the device exposed to the public Internet based on the match further comprises determining a source port specified by both the connection notification and the scan of the network addresses associated with the public Internet.

5. The method of claim 1, wherein the identifying of the device exposed to the public Internet based on the match further comprises determining a destination port specified by both the connection notification and the scan of the network addresses associated with the public Internet.

6. The method of claim 1, further comprising comparing a connection timestamp associated with the connection notification to a scan timestamp associated with the scan of the network addresses associated with the public Internet.

7. The method of claim 1, wherein the identifying of the device exposed to the public Internet further comprises determining a public network address and a port associated with the device.

8. A computer system that identifies a device exposed to a public Internet, comprising:
at least one central processing unit; and
a memory device storing instructions that, when executed by the at least one central processing unit, perform operations, the operations comprising:
comparing a connection notification reported to an external attack surface management service by a cybersecurity sensory agent via a cloud computing environment to a domain scan of network addresses associated with a domain name; and
identifying the device exposed to the public Internet based on an address match and a port match occurring within a timeframe between the connection notification and the domain scan.

9. The computer system of claim 8, wherein the operations further comprise determining the address match based on a source network address specified by both the connection notification and the domain scan of the network addresses associated with the domain name.

10. The computer system of claim 8, wherein the operations further comprise determining the address match based on a destination network address specified by both the connection notification and the domain scan of the network addresses associated with the domain name.

11. The computer system of claim 8, wherein the operations further comprise determining the port match based on a source port specified by both the connection notification and the domain scan of the network addresses associated with the domain name.

12. The computer system of claim 8, wherein the operations further comprise determining the port match based on a destination port specified by both the connection notification and the domain scan of the network addresses associated with the domain name.

13. The computer system of claim 8, wherein the operations further comprise comparing a connection timestamp associated with the connection notification to a domain scan timestamp associated with the domain scan of the network addresses associated with the domain name.

14. The computer system of claim 8, wherein the operations further comprise determining a public network address and a port associated with the device exposed to the public Internet.

15. A memory device storing instructions that, when executed by a central processing unit, perform operations, comprising:
receiving a connection notification reported by a cybersecurity sensory agent via a cloud computing environment to an external attack surface management service;
receiving a packet header specifying a source network address forwarded by the cybersecurity sensory agent via the cloud computing environment to the external attack surface management service;
comparing the connection notification to a domain scan of network addresses associated with a domain name; and
identifying a device exposed to a public Internet by the external attack surface management service based on the source network address and a port match occurring within a timeframe between the connection notification and the domain scan.

16. The memory device of claim 15, wherein the operations further comprise determining the port match based on a source port specified by both the connection notification and the domain scan of the network addresses associated with the domain name.

17. The memory device of claim 15, wherein the operations further comprise determining the port match based on a destination port specified by both the connection notification and the domain scan of the network addresses associated with the domain name.

18. The memory device of claim 15, wherein the operations further comprise determining the source network address is matched to both the connection notification and the domain scan of the network addresses associated with the domain name.

19. The memory device of claim 15, wherein the operations further comprise comparing a connection timestamp associated with the connection notification to a domain scan timestamp associated with the domain scan of the network addresses associated with the domain name.

20. The memory device of claim 15, wherein the operations further comprise determining a public network address and a port associated with the device exposed to the public Internet.
